(19) United States
(12) Patent Application Publication
(10) Pub. No.: US 2002/0027347 A1
(43) Pub. Date: Mar. 7, 2002

(54) Bidirectional data transmission system, units for the same, airbag device and seat belt retractor

(76) Inventor: Hitoshi Fujita, Tokyo (JP)

Correspondence Address: KANESAKA AND TAKEUCHI, 1423 Powhatan Street, Alexandria, VA, 22314, US

(21) Appl. No.: 09/941,720

(22) Filed: Aug. 30, 2001

(30) Foreign Application Priority Data
Sep. 4, 2000 (JP) 2000-266676

(51) Int. Cl. B60R 21/32

(52) U.S. Cl. 280/735; 280/734

(57) ABSTRACT

A bidirectional data transmission system uses two wire lines in which bidirectional communications can be achieved by a simple control circuit. The system includes a first unit, a second unit, and two wire lines for connecting the first unit and the second unit to bidirectionally communicate data between the first unit and the second unit. A data transmission from the first unit to the second unit is conducted by varying voltage between the two wire lines, and a data transmission from the second unit to the first unit is conducted by varying current flowing through the two wire lines.

### BACKGROUND OF THE INVENTION AND RELATED ART STATEMENT

The present invention relates to a bidirectional data transmission system using two wire lines for bidirectional data transfer, units for the system, an airbag device and a seat belt retractor including such units.

Normally, if it is desired to bidirectionally transmit data between two devices, three wire lines are required, one for one direction, one for the other direction, and one for grounding i.e. an earth line. Power sources are generally required for the devices, respectively.

FIG. 4 shows an example of a communication system in an airbag system installed in a passenger car. In FIG. 4, a satellite sensor may be a collision predictive sensor, such as an accelerometer and a sensor for sensing a distance between vehicles, or a collision predictive device. An airbag ECU may be a controller for controlling the deployment of an airbag. Communication between the satellite sensor and the airbag ECU is made. The satellite sensor and the airbag ECU have a common earth line GND and still have a signal wire line for sending a signal from the satellite sensor to the airbag ECU and a signal wire line for sending a signal from the airbag ECU to the satellite sensor. Variations in voltage between each signal wire line and the earth line operate as signals. Power is supplied to the satellite sensor and the airbag ECU from a battery, respectively.

On the other hand, in a general communication technical field, a technology using two wire lines for bidirectional communication has been widely used.

However, such a communication system using three wire lines has a problem of increasing the number of wire lines. In addition, such a communication system using two wire lines for bidirectional communication requires complex communication protocols, which increases the cost of its controller.

The present invention has been made under these circumstances, and an object of the present invention is to provide a bidirectional transmission system which enables the bidirectional transmission by using only two wires and a simple control circuit, and units in the system, and to provide an airbag device and a seat belt device which employ the aforementioned bidirectional transmission system.

### SUMMARY OF THE INVENTION

The first means for solving the aforementioned problems is a bidirectional data transmission system comprising a first unit, a second unit, and two wire lines which connect the first unit and the second unit to bidirectionally communicate data between the first unit and the second unit. The data transmission from the first unit to the second unit is conducted by varying voltage between the two wire lines and the data transmission from the second unit to the first unit is conducted by varying current flowing through the two wire lines.

According to this means, the data transmission from the first unit to the second unit is conducted by varying the voltage between the two wire lines connecting the units in the first unit, and reading this variation in the second unit. During this, variation in current flowing the two wire lines is set not to be so large as to cause a problem.

Data transmission from the second unit to the first unit is conducted by varying the current flowing through the two wire lines in the second unit, and reading this variation in the first unit. During this, variation in voltage between the two lines is set not to be so large as to cause a problem. In this manner, bidirectional data transmission using only two wire lines can be achieved by a simple control circuit without complex communication protocols.

The second means for solving the aforementioned problems is the same as the aforementioned first means, wherein the two wire lines also function as power supply lines from the first unit to the second unit.

According to this means, the two wire lines which are communication lines can be used also as power supply lines. The voltage between the two lines is modulated according to data to be transmitted from the first unit to the second unit in such a manner that low-level voltage as one of signal logical value should be retained higher than the voltage used in electric circuits in the second unit. In this manner, power can be supplied to the electric circuits in the second unit through the constant-voltage power source. According to this means, the communication lines can be used also as power supply lines to the second unit, thereby further reducing the number of wire lines.

The third means for solving the aforementioned problems is the same as the aforementioned first means, wherein the first unit comprises a constant-voltage power source circuit, a voltage modulation circuit connected to the constant-voltage power source circuit, and a current variation detection circuit connected to the voltage modulation circuit; and the second unit comprises a voltage variation detection circuit and a current modulation circuit for modulating current flowing through the two wire lines. The voltage modulation circuit of the first unit, and the voltage variation detecting circuit and the current modulation circuit of the second unit are directly or indirectly connected to each other.

In the first unit according to this means, the voltage modulation circuit connected to the constant-voltage power source modulates the output voltage according to data to be transmitted, thereby varying the voltage between the two wire lines connecting the two units according to the data to be transmitted. The current variation detection circuit for detecting current flowing through the two wire lines is provided at the output side of the voltage modulation circuit, that is, one of the two wire lines. Then, by detecting the flowing current, the current variation detection circuit receives the data transmitted from the second unit.

In the second unit, the voltage variation detection circuit receives the data transmitted from the first unit by measuring the voltage between the two wire lines. The current modulation circuit modulates the current flowing through the two wire lines according to the data to be transmitted. In this manner, the current flowing through the two wire lines connecting the two units is varied according to the data to be transmitted.

It should be noted that the term “indirectly” means “through another electric circuit such as a buffer, impedance transducer, or an amplifier”.

The fourth means for solving the aforementioned problems is the bidirectional data transmission system as the third means, wherein the two wire lines are connected to a constant-voltage power source of the second unit.

According to this means, since the two wire lines used as data communication lines are connected to the constant-voltage power source of the second unit, the data communication lines can be used as power supply to the electric circuits of the second unit.

The fifth means for solving the aforementioned problems is any one of the first means through the fourth means, wherein the first unit has a data transmission control device. The data transmission control device controls not to transmit any data from the first unit for a predetermined period from a point when current flowing through the two wire lines departs from a normal range.

If there is a possibility that data are transmitted simultaneously from the both units when only two wire lines are used for the bidirectional data transmission, control for the simultaneous data transmission is required. The departure from the normal range of current flowing through the two wire lines means that some data begins to be transmitted from the second unit to the first unit.

According to this means, the data transmission control device of the first unit detects when the current departs from the normal range and then controls not to transmit data form the first unit for a predetermined period from a point when the current flowing through the two wire lines departs from the normal range. The predetermined period is preferably a period of time required for transmitting data from the second unit. This can prevent the confusion in communication due to the simultaneous data transmission from the respective units.

The sixth means for solving the aforementioned problems is any one of the first means through the fifth means, wherein the second unit has a data transmission control device. The data transmission control device controls not to transmit any data from the second unit for a predetermined period from a point when voltage applied to the two wire lines departs from a normal range.

The departure from the normal range of voltage between the two wire lines means that some data begins to be transmitted from the first unit to the second unit. According to this means, the data transmission control device of the second unit detects when the voltage departs from the normal range and then controls not to transmit data from the second unit for a predetermined period from a point when the voltage between the two wire lines departs from the normal range. The predetermined period is preferably a period of time required for transmitting data from the first unit. This can prevent the confusion in communication due to the simultaneous data transmission from the respective units.

The seventh means for solving the aforementioned problems is the first unit used in any one of the first means through the sixth means.

The eighth means for solving the aforementioned problems is the second unit used in any one of the first means through the sixth means. These means may be used in any one of the first means through the sixth means.

The ninth means for solving the aforementioned problems is an airbag device comprising the seventh means or the eighth means.

The tenth means for solving the aforementioned problems is a seat belt retractor comprising the seventh means or the eighth means. These means can communicate data with another control circuit or sensor circuit via two wire lines.

### BRIEF DESCRIPTION OF THE DRAWINGS

FIG. 1 is a block diagram showing a first embodiment of the present invention;

FIG. 2 is a block diagram showing a second embodiment of the present invention;

FIG. 3 is a block diagram showing a third embodiment of the present invention; and

FIG. 4 is a diagram showing a conventional communication system in an airbag system installed in a passenger car.

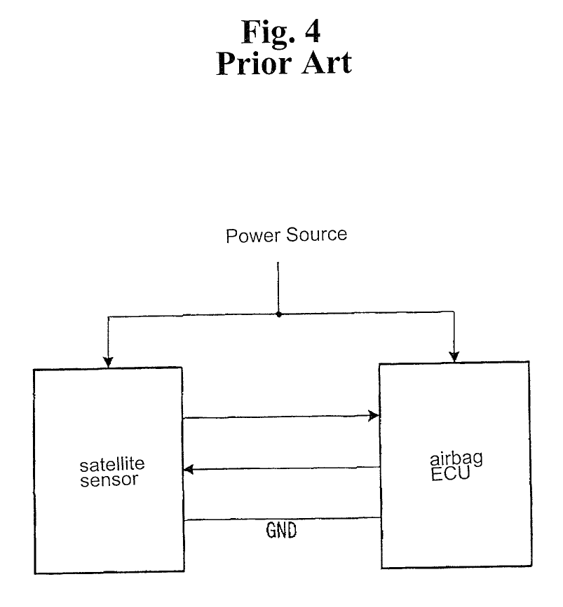

### DETAILED DESCRIPTION OF PREFERRED EMBODIMENTS

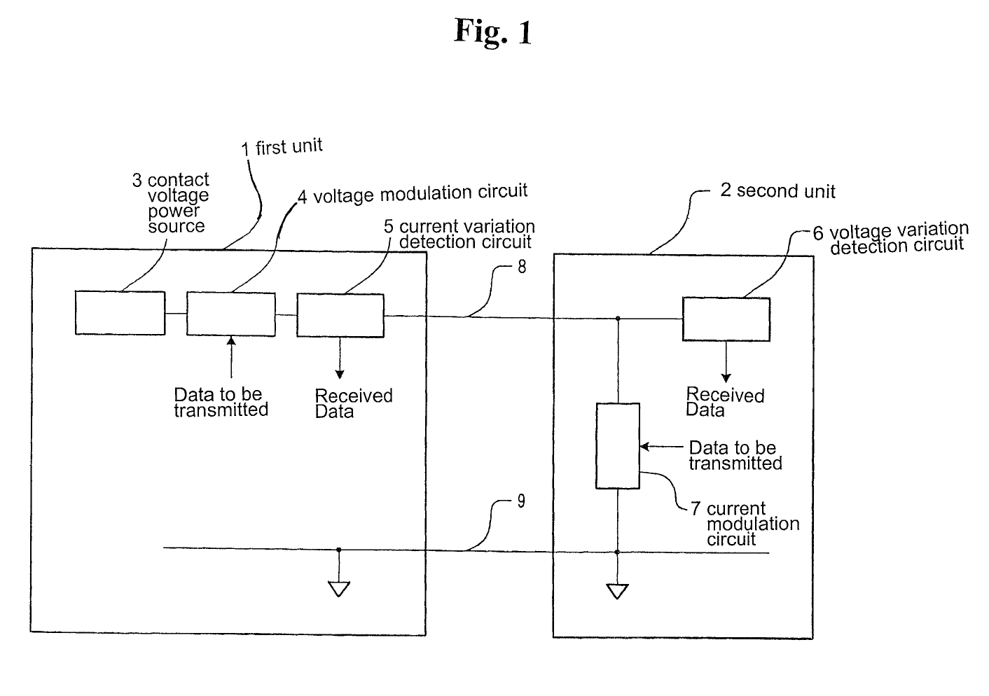

Hereinafter, the present invention will be described with reference to the attached drawings. FIG. 1 is a block diagram showing a first embodiment of the present invention. In FIG. 1, reference numeral 1 designates a first unit, 2 designates a second unit, 3 designates a constant-voltage power source, 4 designates a voltage modulation circuit, 5 designates a current variation detection circuit, 6 designates a voltage variation detection circuit, 7 designates a current modulation circuit, and 8, 9 designate wire lines.

The first unit 1 and the second unit 2 are connected to each other by two wire lines 8, 9. The wire line 9, i.e. one of the two wire lines, is grounded. For transmitting data from the first unit 1 to the second unit 2, the voltage modulation circuit 4 modulates the output voltage according to the data to be transmitted. The modulated voltage is applied to the wire line 8 through the current variation detection circuit 5. During this, the impedance of the current variation detection circuit 5 is sufficiently lowered to have little difference between the output voltage of the voltage modulation circuit 4 and the voltage to be applied to the wire line 8. The voltage applied to the wire line 8 is transmitted to and received by the voltage variation detection circuit 6 of the second unit 2.

For transmitting data from the second unit 2 to the first unit 1, the current modulation circuit 7 modulates a current value flowing through the wire line 8 according to the data to be transmitted. Since the input impedance of the voltage variation detection circuit 6 is high sufficiently, the current flowing through the voltage variation detection circuit 6 is substantially constant so that variation in current caused by the current modulation circuit 7 is substantially faithfully rendered into variation in current flowing through the wire line 8. The variation in current flowing through the wire line 8 is detected and received by the current variation detection circuit 5 of the first unit.

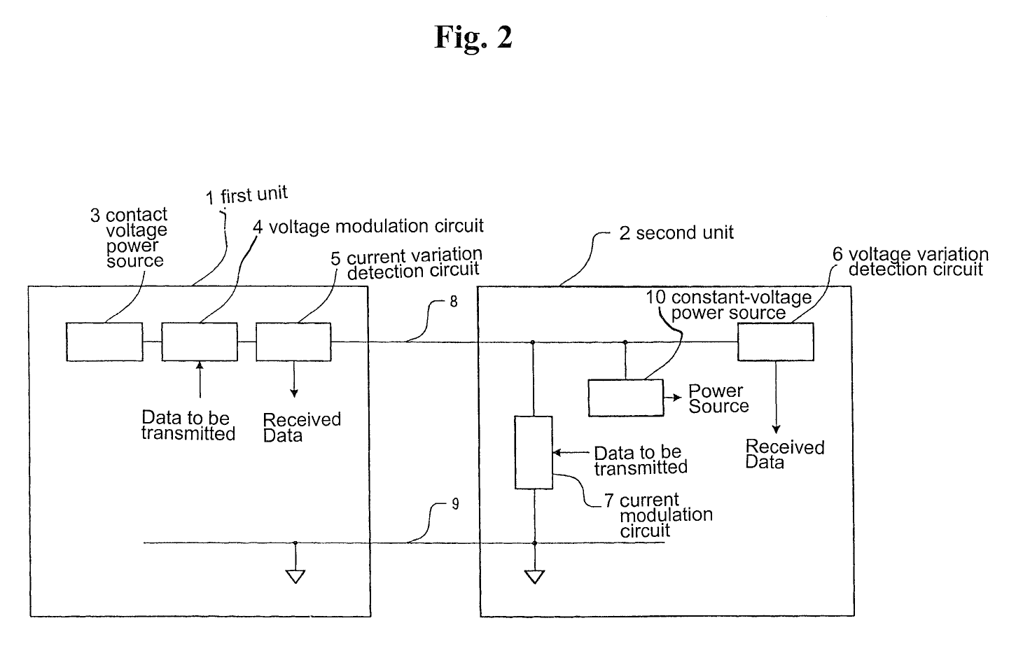

FIG. 2 is a block diagram of a second embodiment of the present invention. In the following drawings, the identical component parts are designated with the same reference numeral used in FIG. 1 referred above, thus omitting the description of these parts. In FIG. 2, reference numeral 10 designates a constant-voltage power source.

The embodiment shown in FIG. 2 is similar to the embodiment shown in FIG. 1, except that the constant-voltage power source 10 is arranged in the second unit 2. The description will be made only as regard to this different point. The constant-voltage power source 10 is used for supplying power to the electric circuit of the second unit 2. In a bidirectional transmission system of this type, voltage used as communication signals should be retained higher than the output of the constant-voltage power source 10. For example, when an output signal of the constant-voltage power source 10 is 5V, the communication signals are set such that a high-level signal is about 10V and a low-level signal is about 8V.

It is required to consider the current consumed by the constant-voltage power source 10 in case of current signals are transmitted from the second unit 2 to the first unit 1. That is, since the current flowing through the wire line 8 corresponds to the total of the current flowing through the current modulation circuit 7 and the current consumed by the constant-voltage power source 10, it is necessary to consider the current consumption by the constant-voltage power source 10 for discriminating the signals in the current variation detection circuit 5. Assuming that the current consumed by the constant-voltage power source 10 is substantially constant, a value obtained by subtracting the current consumed by the constant-voltage power source 10 from the current just detected is assumed as a signal factor. When the current consumption by the constant-voltage power source 10 varies, it is required to design that the current modulation circuit 7 modulates current to sufficiently large amount to ensure the signal discrimination even if the current consumption by the constant-voltage power source 10 varies.

When the aforementioned bidirectional transmission system is employed for an airbag system or a seat belt system, it is preferable that the first unit 1 is arranged at an airbag deployment device or a seat belt retractor (pre-tensioner). This is because such devices require large power. When the first unit 1 is arranged at the device requiring a large power and the second unit 2 is arranged at a device, such as a collision predictive device, not requiring large power, the power consumption by the constant-voltage power source 10 can be made small and the variation in the power consumption can also be made small as compared to the contrary case.

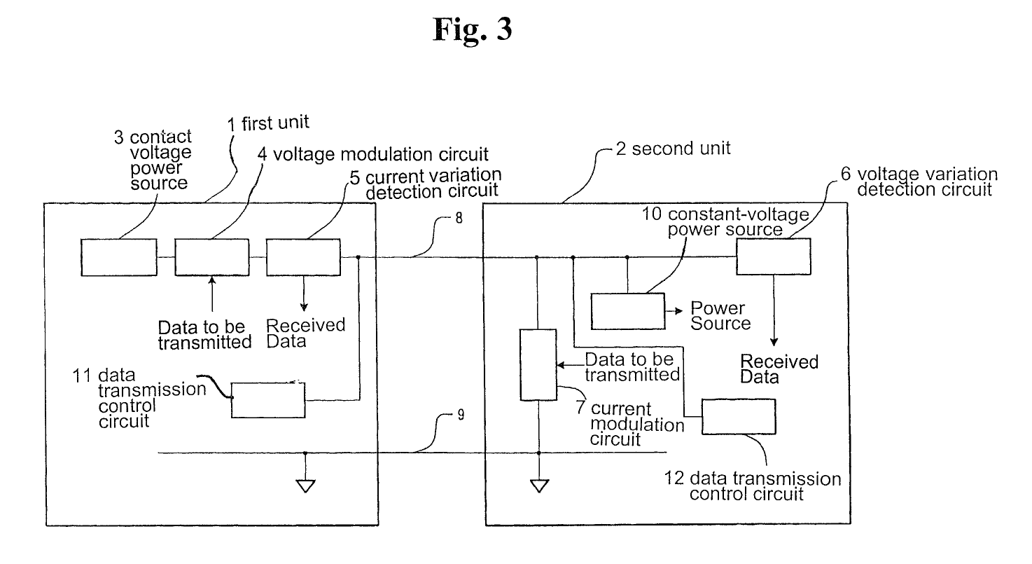

FIG. 3 is a block diagram showing a third embodiment of the present invention. In FIG. 3, reference numerals 11, 12 are data transmission control circuits. This embodiment is similar to the embodiment shown in FIG. 2, except that the data transmission control circuits 11, 12 are provided. The description will be made only as regard to this different point.

The data transmission control circuit 11 monitors the current flowing through the wire line 8 to detect when the current departs from a normal range, i.e. current value when no data transmission is conducted. When departure from the normal range is detected, the data transmission control circuit 11 stops the operation of the voltage modulation circuit 4 for a predetermined period from a detected point, thereby stopping data transmission from the first unit 1 to the second unit 2. That is, data transmission from the first unit 1 is stopped while any data is transmitted from the second unit 2 to the first unit 1, thereby preventing the communication interference. The aforementioned predetermined period is set to be longer than the time required for transmitting data from the second unit 2 to the first unit 1. The impedance of the data transmission control circuit 11 is preferably set as high as possible so as to enable the output of the voltage modulation circuit 4 to be faithfully applied to the wire line 8.

The data transmission control circuit 12 monitors the voltage of the wire line 8 to detect when the voltage departs from a normal range, i.e. voltage when no data transmission is conducted. When departure from the normal range is detected, the data transmission control circuit 12 stops the operation of the Current modulation circuit 7 for a predetermined period from a detected point, thereby stopping data transmission from the second unit 2 to the first unit 1. That is, the data transmission from the second unit 2 is stopped while any data is transmitted from the first unit 1 to the second unit 2, thereby preventing the communication interference. The aforementioned predetermined period is set to be longer than the time required for transmitting data from the first unit 1 to the second unit 2. The impedance of the data transmission control circuit 12 is preferably set as high as possible so as to enable the output of the current modulation circuit 7 to flow faithfully through the wire line 8.

As described above, according to the first and third aspects of the present invention, bidirectional data transmission using only two wire lines can be achieved by a simple control circuit without complex communication protocols.

According to the second and fourth aspects of the present invention, one wire line can be used as both communication wire line and power supply line for a second unit, thereby reducing the number of wire lines.

According to the fifth and sixth aspects of the present invention, the confusion in communication due to the simultaneous data transmission from the respective units can be prevented.

The seventh and eighth aspects of the present invention can be applied to any one of first to sixth aspects. According to the ninth and tenth aspects of the present invention, data communication relative to other control circuits and/or sensor circuits can be achieved by two wire lines.

While the invention has been explained with reference to the specific embodiments of the invention, the explanation is illustrative and the invention is limited only by the appended claims.

What is claimed is:

1. A bidirectional data transmission system, comprising:
a first unit, a second unit, and two wire lines for connecting the first unit and the second unit to bidirectionally communicate data between the first unit and the second unit, wherein a data transmission from the first unit to the second unit is conducted by varying voltage between the two wire lines, and a data transmission from the second unit to the first unit is conducted by varying current flowing through the two wire lines.

2. A bidirectional data transmission system as claimed in claim 1, wherein said two wire lines also function as power supply lines from the first unit to the second unit.

3. A bidirectional data transmission system as claimed in claim 1, wherein said first unit comprises a constant-voltage power source circuit, a voltage modulation circuit connected to the constant-voltage power source circuit, and a current variation detection circuit connected to the voltage modulation circuit; and said second unit comprises a voltage variation detection circuit and a current modulation circuit for modulating current flowing through said two wire lines, said voltage modulation circuit of the first unit and the voltage variation detecting circuit and the current modulation circuit of the second unit being directly or indirectly connected to each other.

4. A bidirectional data transmission system as claimed in claim 3, wherein said second unit further includes a constant-voltage power source to which said two wire lines are connected.

5. A bidirectional data transmission system as claimed in claim 1, wherein said first unit has a first data transmission control device, which controls not to transmit any data from the first unit for a predetermined period from a point when current flowing said two wire lines departs from a predetermined range.

6. A bidirectional data transmission system as claimed in claim 1, wherein said second unit has a second data transmission control device, which controls not to transmit any data from the second unit for a predetermined period from a point when voltage applied to said two wire lines departs from a predetermined range.

7. Said first unit used in the bidirectional data transmission system as claimed in claim 1.

8. Said second unit used in the bidirectional data transmission system as claimed in claim 1.

9. An airbag device comprising at least one of the first and second units as claimed in claim 1.

10. An air bag device as defined in claim 9, further comprising an airbag deployment device containing the first unit, and a collision predictive device containing the second unit.

11. A seat belt retractor comprising at least one of the first and second units as claimed in claim 1.

12. A seat belt retractor as defined in claim 11, further comprising a retractor control device containing the first unit, and a collision predictive device containing the second unit.
